(19) United States
(12) Patent Application Publication
(10) Pub. No.: US 2025/0379472 A1
(43) Pub. Date: Dec. 11, 2025

(54) SYSTEMS, METHODS, AND ADAPTIVE CIRCUITRY FOR DELIVERING AN ELECTROMAGNETIC WAVE BASED ON AN ANGLE-OF-ARRIVAL OF AN ELECTROMAGNETIC SIGNAL

(71) Applicant: The Trustees of Indiana University, Bloomington, IN (US)

(72) Inventors: Peter J. Schubert, Carmel, IN (US); John Bucknell, Troy, MI (US)

(73) Assignee: Virtus Solis Technologies, Inc., Troy, MI (US)

(21) Appl. No.: 18/874,376

(22) PCT Filed: Jul. 31, 2023
(86) PCT No.: PCT/US2023/029105

§ 371 Date: Dec. 12, 2024

Related U.S. Application Data
(60) Provisional application No. 63/393,642, filed on Jul. 29, 2022.

(51) Int. Cl. H02J 50/20; H02J 50/80

(52) U.S. Cl. CPC H02J 50/20; H02J 50/80

(57) ABSTRACT

Systems and methods capable of high precision detection of the angle-of-arrival of a pilot signal over long distances from a precisely located receiver. Such a method includes providing a power transmitter apparatus and a receiver apparatus separated by a distance in space, sending a pilot signal from the receiver apparatus toward the power transmitter apparatus, and the power transmitter apparatus determining the angle of arrival of the pilot signal with fine angular resolution.

### CROSS-REFERENCE TO RELATED APPLICATIONS

This application claims the benefit of U.S. Provisional Application No. 63/393,642 filed Jul. 29, 2022, the contents of which are incorporated herein by reference.

### BACKGROUND OF THE INVENTION

The present invention generally relates to systems and methods of wirelessly delivering electromagnetic power to remote locations. The invention particularly relates to systems and methods that utilize adaptive circuitry capable of providing extremely high precision in determining the angle-of-arrival of a pilot signal from a receiver to enable a transmitter to accurately deliver an electromagnetic wave to the receiver.

Wireless power transfer (WPT) generally refers to methods by which electrical energy (power) is wirelessly transmitted between a transmitting device (transmitter) and a receiving device (receiver) without the use of wires over which the electrical energy is transmitted from the transmitter to the receiver. WPT systems utilize a power transmitter that generates and transmits an electromagnetic wave (beam) through space to a receiver that receives and converts the electromagnetic wave to energy for use by an electrical system. Near field and far-field applications exist for WPT. As used herein, near field applications involve the transfer of power over relatively short distances using magnetic or electric fields and inductive or capacitive coupling, with inductive coupling techniques finding wide use in consumer goods, implantable medical devices, etc. In contrast, far-field WPT (also known as power beaming) is used herein to refer to the transfer of power over longer distances with a beam of electromagnetic radiation, for example, microwaves (radio waves) or a laser beam. Due to having the capability of transmitting power over very long distances, far-field WPT has potential applications with outer space systems in which objects are separated by distances that partially comprise or entirely consist of outer space, as nonlimiting examples, between manmade or natural terrestrial or extraterrestrial objects, including but not limited to satellites, the Earth, the Moon, planets, etc. A particular but nonlimiting example is delivering power from a manmade satellite orbiting the Earth to a ground station on the Earth.

A challenge with implementing far-field WPT techniques is the requirement for the power transmitter to accurately aim the electromagnetic beam at the receiver. Existing methods include corner reflectors, Van Atta arrays, and heterodyned phase conjugated retrodirective beams (RDBs). These methods have accuracy in the range of +/− one degree, and are subject to many deficiencies in noise, signal leakage, and limited return signal strength. Furthermore, phase conjugation is suitable for short range and low power (e.g., communications) but is inadequate for power beaming across long distances. As examples, see Pon, “Retrodirective array using the heterodyne technique,” IEEE Trans. Anten. Propag., Vol. 12, No. 2, 176-180, 1964, and Chen et al., “Overview on the Phase Conjugation Techniques of the Retrodirective Array,” Int'l. J. Antennas and Prop., 2010, ID 564357, doi: 10.1155/2010/564357.

In view of the above, it can be appreciated that there are certain problems, shortcomings, or disadvantages associated with the prior art, and that it would be desirable if systems and methods were available and capable of utilizing far-field WPT techniques to accurately aim an electromagnetic beam the over long distances to a precisely-located receiver.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems and methods that are capable of determining with high precision the direction at which an electromagnetic wave (beam) is transmitted over long distances.

According to a nonlimiting aspect of the invention, a method is provided for determining an angle-of-arrival of a pilot signal of electromagnetic energy sent from a receiver apparatus to receivers associated with a power transmitter apparatus. The method includes providing the power transmitter apparatus and the receiver apparatus separated by a distance in space, sending the pilot signal from the receiver apparatus toward the power transmitter apparatus, and the power transmitter apparatus determining the angle of arrival of the pilot signal with an angular resolution.

According to a preferred but nonlimiting aspect of the invention, a method as described above additionally transmits an electromagnetic wave to the receiver apparatus. The method includes sending a communication signal from the first location of the power transmitter apparatus to the second location of the receiver apparatus, adaptively modulating the pilot signal to have a variable number of pulses that is increased or decreased based on the communication signal from the power transmitter apparatus, processing the pilot signal with signal processing circuitry having a variable gain of amplification to produce a voltage signal corresponding to the number of pulses in the pilot signal, wherein the angle of arrival of the pilot signal is determined with the voltage signal and the power transmitter apparatus generates and transmits the electromagnetic wave to the receiver apparatus based on the angle of arrival of the pilot signal.

Other nonlimiting aspects of the invention include systems and adaptive circuitries adapted to perform steps of the method described above. As an example, such a system includes the power transmitter apparatus and the receiver apparatus located at the first and second locations, respectively, means associated with the receiver apparatus for generating and sending the pilot signal from the receiver apparatus toward the power transmitter apparatus, means associated with the power transmitter apparatus for determining the angle of arrival of the pilot signal from the receiver apparatus and generating and transmitting the electromagnetic wave to the receiver apparatus, means for sending the communication signal from the first location of the power transmitter apparatus to the second location of the receiver apparatus, means for adaptively modulating the pilot signal to have a variable number of pulses during a reset cycle, and the signal processing circuitry comprising a detection circuitry having a variable gain of amplification to adaptively modulate the variable gain of amplification and storing the adaptively modulated gain of amplification and the number of pulses.

Technical aspects of systems, methods and circuitry as described above preferably include the ability to address challenges with implementing far-field WPT techniques, particularly the requirement for the power transmitter apparatus to accurately aim the electromagnetic beam over long distances to a precisely-located receiver. The power transmitter apparatus is preferably capable of determining the angle of arrival of a pilot signal with an extremely fine angular resolution that is less than typically available in conventional angle-of-arrival systems and methods.

Other aspects and advantages will be appreciated from the following detailed description.

### BRIEF DESCRIPTION OF THE DRAWINGS

FIG. 1 schematically represents a far-field wireless power transfer (WPT) system having a power transmitter apparatus adapted to wirelessly transmit through space an electromagnetic (power) wave (beam) to a receiver apparatus in accordance with a nonlimiting aspect of the invention.

FIGS. 2A and 2B represent a modulation scheme that is capable of use in the WPT system of FIG. 1, wherein a pilot signal is capable of being generated with a variable number of pulses and transmitted from the receiver apparatus to the power transmitter apparatus utilizing a variable frequency or variable duty cycle envelope.

FIG. 3 schematically represents detection circuitry associated with the power transmitter apparatus of FIG. 1. The detection circuitry includes a phase-frequency detector (PFD) that provides a signal proportional to the different time of arrival of a substantially plane wave electromagnetic pilot signal at antennae associated with the power transmitter apparatus. The PFD is depicted as producing an output QA pulse, which is a square wave pulse having a width proportional to the different time of arrival. The PFD is also depicted as producing an output QB pulse, which is a narrow square wave pulse that is equal to or shorter in duration than the QA pulse. An operational amplifier (OpAmp) subtracts QB from QA to produce an output that is the difference in duration between the QA and QB pulses, and thereby proportional to the different time of arrival, and hence proportional to the angle-of-arrival, of the pilot signal. The output of the OpAmp is accumulated (summed) on an RC low-pass filter (LPF), producing a voltage output (voltage signal) Vₒᵤₜ. FIG. 3 represents the use of a Vreset signal to drain the charge from a capacitor of the LPF to prepare the LPF for a subsequent determination of the angle-of-arrival of the pilot signal.

FIGS. 4A and 4B schematically represent a (one-dimensional) power transmitter circuit including a phased array antenna associated with the power transmitter apparatus of FIG. 1. In combination, the power transmitter circuit and phase array antenna are adapted to generate the electromagnetic beam of the power transmitter apparatus, aim the electromagnetic beam, and then wirelessly transmit (deliver) the beam to the precise location of the pilot signal generated by the receiver apparatus.

FIGS. 5A and 5B schematically represent a manner in which the modulation schemes of FIGS. 2A and 2B, the detection circuitry of FIG. 3, and the power transmitter circuit of FIGS. 4A and 4B are capable of providing a span of gain and logic for adaptively modulating the number of pulses between readings of the voltage signal (Vₒᵤₜ) via the pilot signal generated at the receiver apparatus.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated. Therefore, the appended claims, and not the detailed description, are intended to particularly point out subject matter regarded to be aspects of the invention, including certain but not necessarily all of the aspects and alternatives described in the detailed description.

The present invention is directed to methods and systems capable of wirelessly transmitting electromagnetic power from a power transmitter apparatus to a remotely located receiver apparatus, providing what is referred to herein as wireless power transfer (WPT). The methods and systems are preferably capable of use with outer space systems in which objects are separated by distances that partially comprise or entirely consist of outer space, as nonlimiting examples, between manmade or natural terrestrial or extraterrestrial objects, including but not limited to satellites, the Earth, the Moon, planets, etc. A particular but nonlimiting example is the delivery of power from manmade satellites orbiting the Earth to ground stations on the Earth for use by terrestrial power consumers.

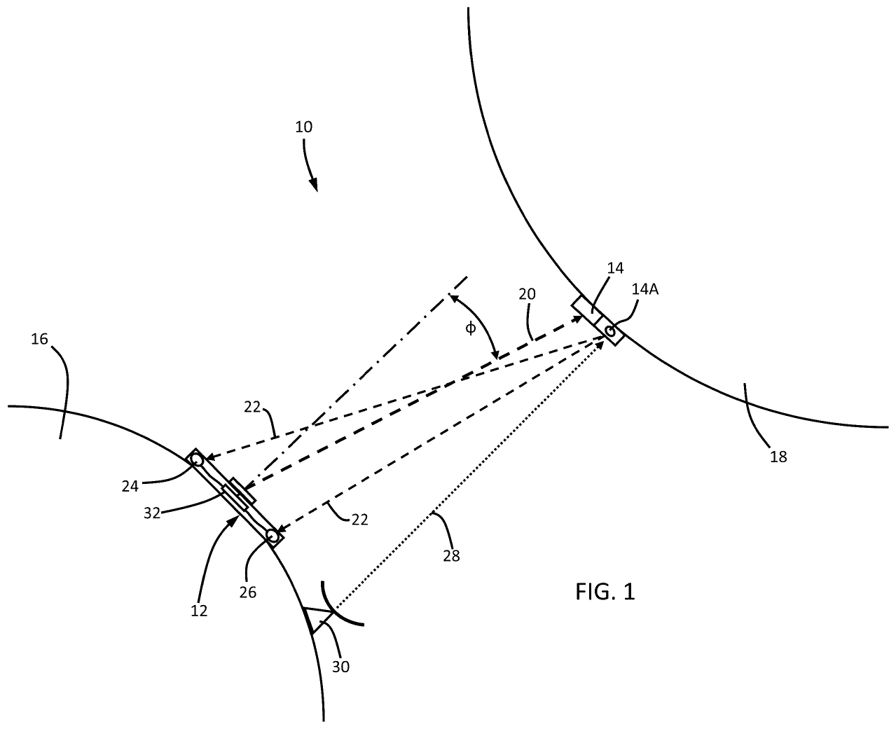

FIG. 1 schematically represents a far-field WPT system 10 comprising a power transmitter apparatus 12 and a receiver apparatus 14 located remotely from each other at two different locations 16 and 18 separated by a distance that at least partially comprises and may entirely consist of outer space. Either or both locations 16 and 18 may be located on manmade or natural terrestrial or extraterrestrial objects, including but not limited to satellites, the Earth, the Moon, planets, etc. As represented in FIG. 1, the location 18 may be a manmade satellite that receives power from the location 16 on a larger body, for example, a manmade or natural body around which the satellite may be in geosynchronous orbit. As described below, the system 10 is adapted to deliver a beam 20 of an electromagnetic wave (power beam) to the receiver apparatus 14 with high directionality and without disruption of sensitive radio-frequency circuitry away from the receiver apparatus 14 by utilizing in-phase pilot signals 22 (e.g., a substantially plane wave electromagnetic pilot signal) transmitted from a pilot signal transmitting antenna 14A of the receiver apparatus 14 to pilot signal receiving antennae 24 and 26 associated with the transmitter apparatus 12 to determine with high-accuracy an angle-of-arrival of the pilot signal 22 in two dimensions. This information can be used by signal processing circuitry 32 of the transmitter apparatus 12 to deliver the power beam 20 with high directionality to the receiver apparatus 14, which is precisely located at its location 18, e.g., on the Earth.

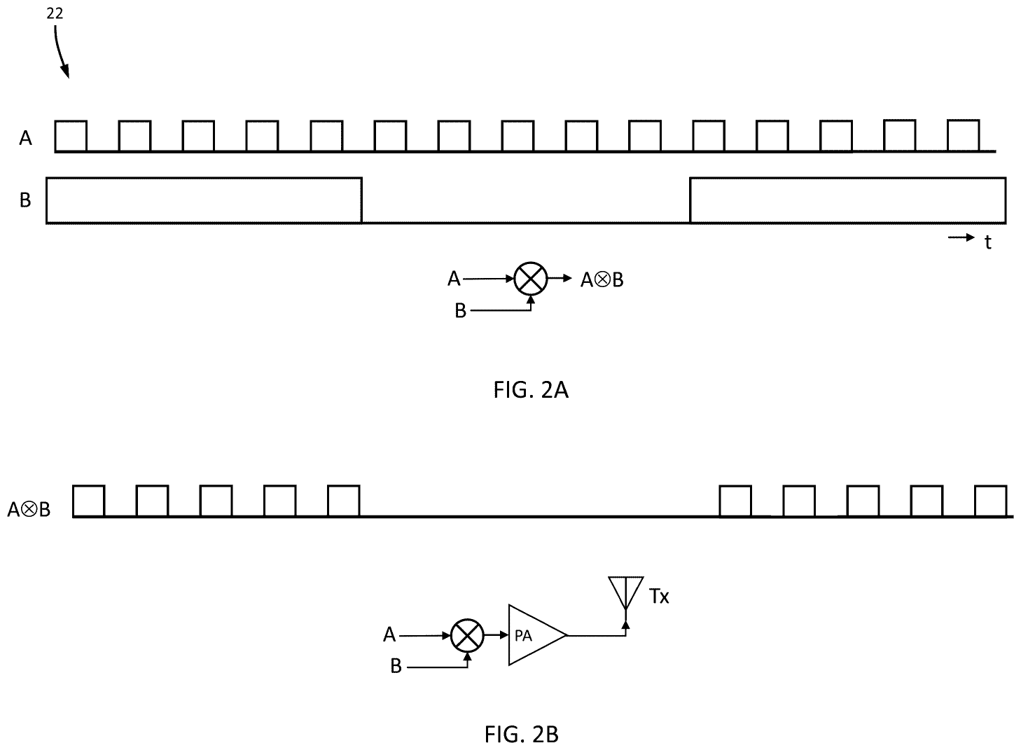

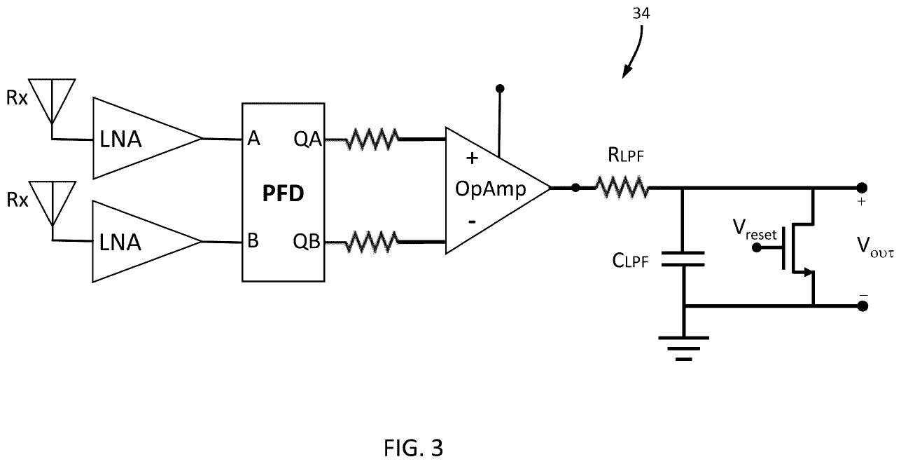

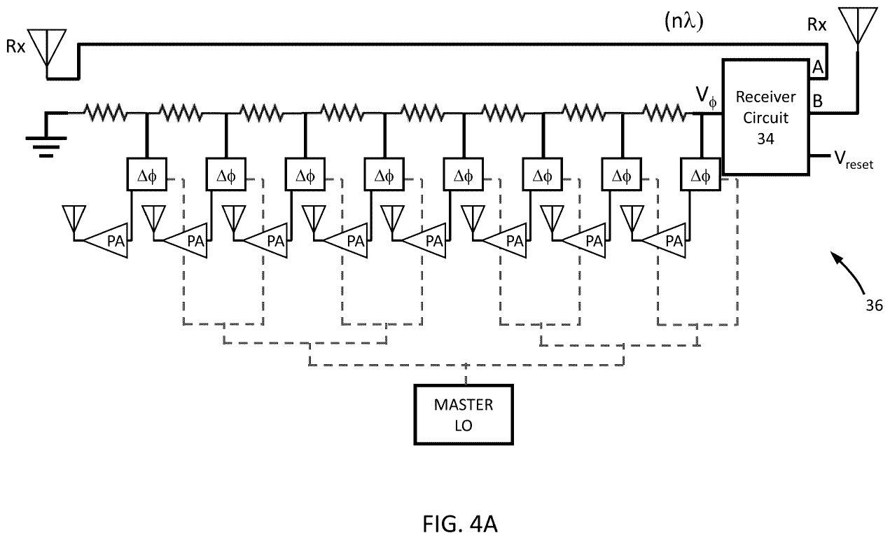

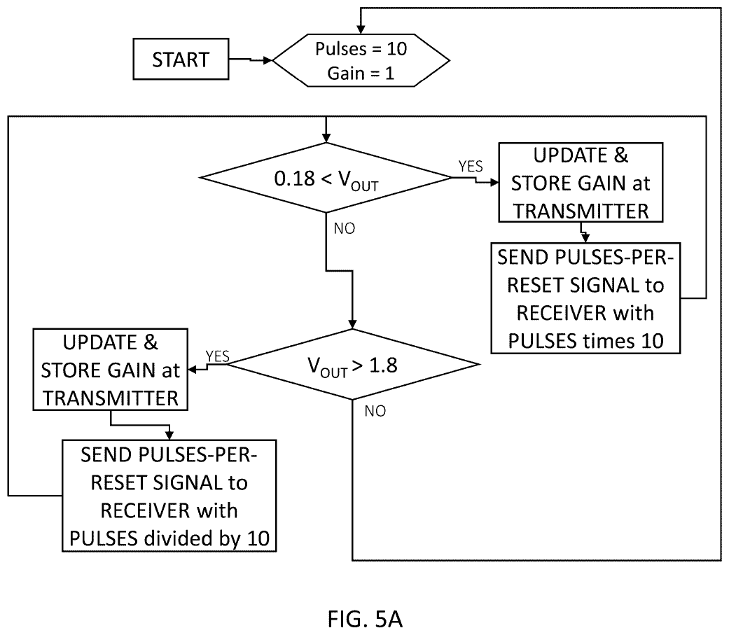

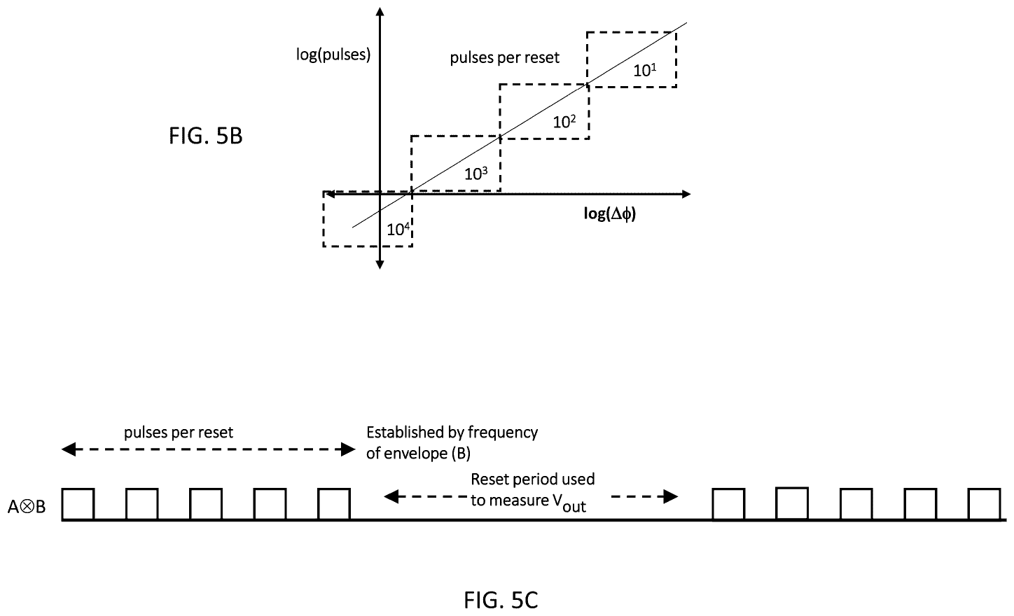

FIGS. 2A through 4B schematically represent circuitry that in combination depict certain aspects of adaptive circuitry utilized by the WPT system 10 to enable high precision in determining the angle-of-arrival of the pilot signal 22 from the receiver apparatus 14 and enable the transmitter apparatus 12 to accurately deliver the electromagnetic power beam 20 to the receiver apparatus 14. FIGS. 5A through 5C schematically represent steps and graphs that in combination depict an exemplary manner in which the adaptive circuitry is capable of providing high precision in determining the angle-of-arrival of the pilot signal 22 from the receiver apparatus 14 to the transmitter apparatus 12. FIGS. 2A and 2B schematically represent schemes and circuit components for generating and transmitting the pilot signals 22 to the pilot signal receiving antennae 24 and 26 associated with the power transmitter apparatus 12. The pilot signal transmitting antenna 14A of the receiver apparatus 14 is represented in FIG. 2A as transmitting a higher frequency waveform (Signal A) and a variable lower frequency envelope waveform (Signal B) at different frequencies, as a nonlimiting example, nominal frequencies of 1.3 MHz and 40 kHz, respectively. Signal B may be varied widely in frequency to increase the number of pulses of Signal A occurring within the time duration when Signal B is at logical HIGH. Signal B may also be varied in duty cycle either with or without changes in frequency, enabling a pilot signal 22 to be generated with a variable number of pulses utilizing a variable frequency or variable duty cycle envelope. Signals A and B are mixed (A⊕B) with a mixer, which may be On-Off Keying (OOK) by toggling the power to a power amplifier (PA in FIG. 2B). Other methods of mixing can be used such as those known to practitioners of ordinary skill in the art of heterodyning. The Signals A and B utilize two function generators that trigger such that rising edges of the waveform occur substantially simultaneously. The adaptability of this scheme is defined by the number of Signal A pulses occurring during the logical HIGH of Signal B, and the number of pulses is variable, i.e., can be adjusted or adapted, as needed to provide a very wide range. A corresponding variable amplifier gain, such as with the OpAmp in FIG. 3, maintains the overall within a range operable by detection circuitry 34 of the signal processing circuitry 32. As an example, the pilot signals 22 may be adaptively modulated as may be needed to increase either angular resolution or frequency of updated angle-of-arrival. This may be accomplished with a separate communications channel established with the pilot signal transmitting antenna 14A of the receiver apparatus 14. In FIG. 1, such a channel is represented as emanating from a communications antenna 30 that may be separate from or part of the transmitter apparatus 12 at or in proximity to the location 16. The communications antenna 30 is represented as delivering a communications signal 28 to the pilot signal transmitting antenna 14A to enable adaptive modulation of the pilot signals 22, for example, an increase or decrease of the number of pulses of Signal A during the time when Signal B is at logical HIGH so as to provide an angle-of-arrival indicator with high accuracy, as a nonlimiting example, approximately one millionth of a degree or less, or alternatively to provide a faster update to the angle-of-arrival, as a nonlimiting example, approximately one microsecond. This control can be exerted utilizing the modulation schemes represented in FIGS. 2A and 2B, in substantial synchrony with variable gain amplifiers in the signal processing circuitry 32 associated with the power transmitting apparatus 12 to provide variable gain (sensitivity). As a preferred embodiment, in the variable frequency scheme of FIG. 2A the logical HIGH duration of the Signal B can be implemented as a change in the frequency of HIGH and LOW. Alternatively, in a variable duty cycle envelope scheme, the HIGH/LOW frequency of Signal B is maintained but the duty cycle of Signal B overlaps with a varying number of pulses of Signal A. These modulation schemes can be exercised in two orthogonal directions to provide elevation (ϕ) and azimuth (θ), so that the power transmitter apparatus 12 can accurately determine the angle-of-arrival, and thus be informed of the direction towards which the power beam 20 is aimed. Though FIG. 1 only makes reference to elevation (ϕ), from the following discussion it will be apparent that azimuth is also addressed.

FIG. 3 schematically represents detection circuitry 34 suitable for use as a component of the signal processing circuitry 32 and communicating with the pilot signal receiving antennae 24 and 26. In the detection circuitry 34 represented in FIG. 3, electrical distances are strictly equal and low noise amplifiers (LNAs) are matched for delay. The detection circuitry 34 includes an operational amplifier (OpAmp) to provide a voltage gain to establish nominal voltage levels suitable for analog-to-digital conversion (ADC) for signal processing by a microprocessor (not shown) of the signal processing circuitry 32. In FIG. 3, a resistor (R) and capacitor (C) constitute a Low-Pass Filter (LPF) which itself operates as an “integrator” by summing signals coming onto the capacitor. The resistor bleeds off the summation slowly, such that the LPF can be described as operating as a “leaky integrator.” The amplified pulses coming onto the capacitor are summed across the duration of time that Signal B is at logical HIGH (accounting for the speed-of-light delay of the pilot signal 22 from the pilot signal transmitting antenna 14A to the pilot signal receiving antennae 24 and 26 of the power transmitter apparatus 12). It is this summed signal on the capacitor that is proportional to the time-of-flight difference between the antennae 24 and 26 that is directly related to the angle of arrival of the pilot signal 22. This is performed by the pair of pilot signal receiving antenna 24 and 26 oriented in a substantially orthogonal arrangement so as to collectively provide triangulation of both angles of arrival of the pilot signal 22, these angles being θ and ϕ (azimuth and elevation, respectively). The summed signal, proportional to the phase difference and hence the angle of arrival, is sensed by the microprocessor via an ADC (not shown) of the signal processing circuitry 32. After reading this signal, the microprocessor initiates a Vreset signal to clear accumulated (summed) charge from the capacitor, making it ready for the next reading. In FIG. 3, Vreset activates a switch, represented as a MOSFET, that discharges the capacitor upon receiving a signal from the microprocessor after a reading has been recorded. As is familiar to one of ordinary skill, all capacitances may not be fully drained, so that an experimentally measured offset may require compensation in the microprocessor.

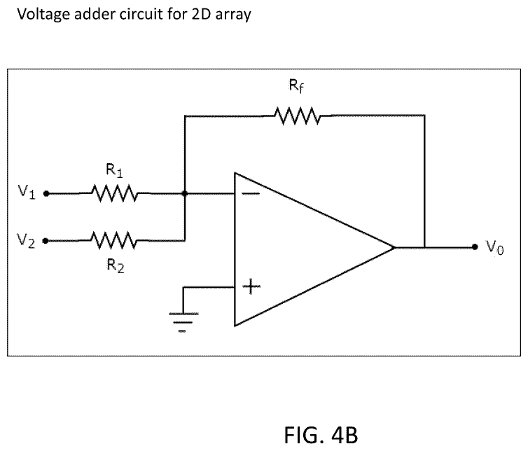

FIGS. 4A and 4B schematically represent the detection circuitry 34 of FIG. 3 incorporated into an architecture of a power transmitter circuit of a phased array antenna 36 associated with the power transmitter apparatus 12 of FIG. 1. The phased array antenna 36 comprises phase shifters (Δϕ) on a resistor ladder so that the phase shifters have proportionally lower voltages and therefore a difference in phase. A master local oscillator (MLO) in a balanced corporate feed configuration provides each phase shifter with the same frequency and an identical reference phase. The power amplifiers (PA) may be fed from a PV bus, or other convenient source of power. Though FIG. 4A schematically represents one dimension only, a substantially similar arrangement can be used to address both azimuth and elevation θ and ϕ, and the voltage signals summed at the phase shifters using the means represented in FIG. 4B.

FIGS. 5A-5C illustrate the manner by which the system can attain adaptive gain for high resolution when detecting the angle-of-arrival of the pilot beam 22. In the nonlimiting example of FIG. 5A, which represents a flow chart depicting steps involved in adaptively modulating the gain and pulses-per-reset, the default starting number is 10 and if Vₒᵤₜ is between 0.18 and 1.8 volts, convenient for ADC, the number of pulses during a reset cycle is maintained. If Vₒᵤₜ is below 0.18 volts, the communications signal 28 (FIG. 1) is sent by the communications antenna 30 to increase the number of pulses by, in this example, 10× per reset cycle of signal (in FIG. 2A, by reducing the variable envelope frequency of Signal B). The gain of the OpAmp in FIG. 3 is reduced accordingly so as to maintain the value of Vₒᵤₜ between 0.18 and 1.8 volts. The gain of the OpAmp and the number of pulses of Signal A in each Signal B envelope are maintained in synchrony via the communications signal 28 and stored locally at both the transmitter apparatus 12 and the receiver apparatus 14. If Vₒᵤₜ is above 1.8 volts, the communications signal 28 is sent to reduce the number of pulses during a reset cycle by increasing the envelope frequency of Signal B to decrease the number of pulses by, in this example, 10× during the reset cycle, and then the gain of the OpAmp of FIG. 3 is updated and this information stored in the microprocessor or system memory (not shown) of the signal processing circuitry 32. The currently stored gain and number of pulses, shared between the transmitter apparatus 12 and the pilot signal transmitting antenna 14A, is used in the computation of phase difference in elevation (phase shifters Δϕ) as shown in FIG. 5B.

FIG. 5B illustrates that the regions of operation are discrete and contiguous. The transmitter apparatus 12 and the receiver apparatus 14 are both aware of the current pulses-per-reset value by the separate communication signals 28 as described above. Alternatively, Signals A and B of FIGS. 2A and 2B could be directly modulated to convey changes in the reset frequency and thereby eliminate the need for a separate communications antenna 30. Such an integrated modulation scheme is within the scope of the invention. Updates to adaptive gain are generally much slower than the reset cycle, thereby avoiding aliasing or jitter. The use of averaging, removal of outliers, and predictive filters are also within the scope of the invention.

The system 10 and its components as described above are preferably capable of being implemented in a far-field WPT technique, enabling the transmitter apparatus 12 to accurately determine the angle-of-arrival of the pilot signals 22, and thereby be capable to aim the electromagnetic power beam 20 for collection by the receiver apparatus 14 precisely located a long distance from the transmitter apparatus 12, such as through outer space. The pilot signal receiving antennae 24 and 26 associated with the power transmitter apparatus 12 are preferably capable of determining the angle of arrival of the pilot signals 22 from the pilot signal transmitting antenna 14A associated with the receiver apparatus 14 with an extremely fine angular resolution, for example, one millionth of a degree, which is smaller than typically available in conventional angle-of-arrival methods.

As previously noted above, though the foregoing detailed description describes certain aspects of one or more particular embodiments of the invention, alternatives could be adopted by one skilled in the art. For example, the system 10 and its components could differ in appearance and construction from the embodiments described herein and shown in the drawings, functions of certain components of the system 10 could be performed by components of different construction but capable of a similar (though not necessarily equivalent) function, and process parameters such as frequencies, durations, etc., could be modified. For example, the voltage ranges and magnitude of sensitivity steps (nominally 10×) may be varied considerably without loss of generality as may be required by considerations of performance for the system 10 and its adaptive circuitry. As such, and again as was previously noted, it should be understood that the invention is not necessarily limited to any particular embodiment described herein or illustrated in the drawings.

1. A method of transmitting an electromagnetic wave, the method comprising:
providing a power transmitter apparatus at a first location and a receiver apparatus at a second location, the first and second locations being separated by a distance in space;
sending a communication signal from the first location of the power transmitter apparatus to the second location of the receiver apparatus;
sending a pilot signal from the receiver apparatus toward the power transmitter apparatus, the pilot signal being adaptively modulated to have a variable number of pulses in a reset cycle wherein the number of pulses is increased or decreased based on the communication signal from the power transmitter apparatus;
processing the pilot signal with signal processing circuitry having a variable gain of amplification to produce a voltage signal corresponding to the number of pulses of the pilot signal;
determining with the voltage signal the angle of arrival of the pilot signal with an angular resolution; and
the power transmitter apparatus generating and transmitting the electromagnetic wave to the receiver apparatus based on the angle of arrival of the pilot signal.

2. The method of claim 1, wherein the angular resolution is one millionth of a degree or less.

3. The method of claim 1, wherein the sending of the communication signal and the sending of the pilot signal are performed in two orthogonal directions to provide angle and azimuth for the angle of arrival of the pilot signal.

4. The method of claim 1, wherein the pilot signal is a plane wave electromagnetic signal.

5. The method of claim 1, wherein the pilot signal from the receiver apparatus is received by at least first and second pilot signal receiving antennas of the power transmitter apparatus.

6. The method of claim 5, wherein the pilot signal is measured using detection circuitry comprising a phase-frequency detector that produces the voltage signal that is adaptively modulated so as to be proportional to a different time of arrival of the pilot signal at the first and second pilot signal receiving antennae and proportional to the angle of arrival of the pilot signal.

7. The method of claim 6, wherein the phase-frequency detector produces first and second output pulses, the first output pulse has a width proportional to the different time of arrival of the pilot signal at the first and second pilot signal receiving antennae, and the second output pulse is equal to or shorter in duration than the first output pulse, the method further comprising summing a number of the first and second output pulses to produce a reading of the voltage signal of the phase-frequency detector that updates the angle of arrival of the pilot signal.

8. The method of claim 7, the method further comprising adaptively decreasing the number of the summed first and second output pulses to provide faster updates of the angle of arrival of the pilot signal.

9. The method of claim 7, the method further comprising adaptively increasing the variable gain of amplification of the summed first and second output pulses to provide the voltage signal within a range operable by the detection circuitry.

10. The method of claim 7, the method further comprising sharing between the power transmitter apparatus and the receiver apparatus the number of the first and second output pulses summed during the reading.

11. The method of claim 7, the method further comprising storing within the detection circuitry the gain of amplification and the number of the summed first and second output pulses summed during the reading.

12. The method of claim 1, further comprising aiming the electromagnetic wave based on the angle of arrival of the pilot signal using a phased array antenna comprising phase shifters, wherein each of the phase shifters has identical reference phases.

13. The method of claim 1, wherein the electromagnetic wave is a power beam.

14. The method of claim 1, wherein the distance in space comprises outer space.

15. The method of claim 1, wherein each of the first and second locations is on a natural terrestrial or extraterrestrial object.

16. The method of claim 15, wherein the first location is on a satellite orbiting the Earth and the second location is on the Earth.

17. A system comprising adaptive circuitry adapted to perform the steps of the method of claim 1.

18. A system comprising adaptive circuitry adapted to perform the steps of the method of claim 6.

19. A system comprising adaptive circuitry adapted to perform the steps of the method of claim 7.

20. The system of claim 17, the system comprising:
the receiver apparatus at the second location;
means associated with the receiver apparatus for generating and sending the pilot signal from the receiver apparatus toward the power transmitter apparatus;
the power transmitter apparatus at the first location;
means associated with the power transmitter apparatus for determining the angle of arrival of the pilot signal from the receiver apparatus and generating and transmitting the electromagnetic wave to the receiver apparatus;
means for sending the communication signal from the first location of the power transmitter apparatus to the second location of the receiver apparatus; and
means for adaptively modulating the pilot signal to have a variable number of pulses that is increased or decreased based on the communication signal from the power transmitter apparatus; and
the signal processing circuitry comprising a detection circuitry having a variable gain of amplification to adaptively modulate the variable gain of amplification and storing the adaptively modulated gain of amplification and the number of pulses.
